(19) United States
(12) Patent Application Publication
(10) Pub. No.: US 2025/0237626 A1
(43) Pub. Date: Jul. 24, 2025

(54) APPARATUS AND METHOD FOR ANOMALY LOCALIZATION IN BRANCHED WAVEGUIDES

(71) Applicant: Southwest Research Institute, San Antonio, TX (US)

(72) Inventors: Sergey A. VINOGRADOV, San Antonio, TX (US); Nikolay AKIMOV, San Antonio, TX (US)

(21) Appl. No.: 19/035,474

(22) Filed: Jan. 23, 2025

Related U.S. Application Data
(60) Provisional application No. 63/623,962, filed on Jan. 23, 2024.

(51) Int. Cl. G01N 29/04; G01N 29/24; G01N 29/34; G01N 29/44

(52) U.S. Cl. CPC G01N 29/04; G01N 29/34; G01N 29/44; G01N 29/2412; G01N 29/2437

(57) ABSTRACT

A method for anomaly localization in a branched structure. The method includes: coupling an ultrasonic pulse generator/receiver circuitry and probe circuitry to the branched structure and generating ultrasonic pulse signals through the branched structure and receiving composite ultrasonic pulse reflection signals; wherein the composite ultrasonic pulse signals represent signal components from branches of the branch structure; coupling a signal modifying device to a selected branch of the branch structure; the signal modifying device to modify the ultrasonic pulse signals to generate modified composite ultrasonic pulse reflection signals; and isolating the modified ultrasonic pulse reflection signal from the modified composite ultrasonic pulse reflection signals to isolate anomalies present in the selected branch of the branch structure.

### FIELD

The present invention is directed to systems and methods for anomaly localization in branched waveguides. More specifically, the systems and methods of the present disclosure provide for separation of wave guide reflections in cases where guided waves propagate/reflect in multiple branching attachments for a given structure.

### BACKGROUND

Ultrasonic guided wave testing is considered well developed for screening pipes, tank walls, tank bottoms, steel ropes, buried anchor rods, heat exchanger tubing, and other industrial structures. Data acquisition includes attaching a guided wave probe to a tested structure at selected location, sending a guided wave down the length of the structure, and recording indications produced in the received signal from the guided wave being reflected by geometry features or anomalies.

In the case of inspection of a structure that does not have any relatively large attachments that can act as a second waveguide, the location of an anomaly can be reliably correlated with the time of flight of the guided wave signal. On the other hand, if the tested structure has a relatively large attachment or shape that bifurcates or branches the structure and creates two or more additional waveguides, it is more difficult to inspect the structure because it is not clear which branch a returned guided wave reflection comes from.

For example, FIG. 1a shows a storage tank geometry with a tank bottom plate that is welded to a vertical tank wall. Even though the guided wave probe (e.g., MsT probe) is located on the tank bottom plate outside of the vertical wall, the ultrasonic signal (guided wave) will leak into the vertical wall at the wall attachment point. FIG. 1b shows an example of data acquired from a tank bottom at 65 kHz frequency (data rectified positive) and at 120 kHz frequency (data rectified negative). An indication is observed in the 120 kHz data that corresponds to a feature in the tank bottom at the 32 ft distance mark. However, at 65 kHz there are several indications (labeled welds 1 and 2 as well as Plate Edge) that are produced from features in the tank wall. The lower frequency guided waves propagate more efficiently in the vertical wall due to its greater thickness compared to the bottom plate. The fact that indications from the tank bottom and tank wall are overlapped in time makes analysis difficult.

A second example demonstrating this bifurcation effect on a tank bottom is shown in FIG. 2. In this case, a section of tank bottom plate and tank wall was simulated in a laboratory mockup. For this example, the data was processing using an array processing algorithm to create two- dimensional images of the structure condition. FIG. 2a shows a guided wave probe positioned on the mockup. FIG. 2b shows several fabricated anomalies in the mockup, including simulated pitting and gradual wall loss. FIG. 2c shows the guided wave inspection results with indications that correspond to these anomalies. Additionally, there are indications that originate from the vertical wall.

FIG. 3 shows a third example of a bifurcated waveguide structure: a branching pipeline. This scenario is quite common in industry because many pipes have multiple branching connections. In this case, defect 1 is located on the tested pipe and defect 2 is located on the branch pipe. Even though the guided wave collar is acoustically coupled to the tested pipe, some energy will leak into the branch pipe, making indications produced by defect 1 in the tested pipe and defect 2 in the branch pipe overlap on an A-scan plot.

FIG. 4 shows a related example where an indication from a defect located on the top segment of the pipe could overlap with another indication produced by another defect located the same distance from the sensor as the first defect in the bottom section of the pipe under a pipe support. The common way to separate indications produced by such defects is to use a segmented sensor with multichannel electronics, allowing individual data collection from each segment. These sensors and electronics are more expensive when compared to single ring probes, and this approach is not effective when the region inspected is located far from the sensor.

FIG. 5 shows another example when a guided wave probe installed on the main cable of a suspension bridge. After propagating some distance from the transducer, the cable splits to multiple strands, each of which form an individual waveguide. The guided wave in this case will branch and enter every individual strand, but it will be impossible to determine which strand produces an indication.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A illustrates an example bifurcated structure to be tested that includes a tank bottom structure and a welded vertical wall;

FIG. 1B illustrates an example plot of data acquired from the tank bottom of FIG. 1A at 65 kHz (data rectified positive and at 120 kHz (data rectified negative);

FIGS. 2A and 2B and 2C illustrate an example demonstrating this bifurcation effect on a tank bottom;

FIGS. 3 illustrates another example bifurcated structure that includes a branching pipeline: FIGS. 4 illustrates another example bifurcated structure that includes a pipeline with a pipe support structure;

FIGS. 5 illustrates a branched structure of cables of a suspension bridge;

FIGS. 6a and 6b illustrates a branched structure that includes a tank bottom and a sidewall structure according to one embodiment of the present disclosure;

FIGS. 7a and 7b illustrate plots corresponding to signal responses of the branched structure of FIGS. 6a and 6b according to one embodiment of the present disclosure;

FIG. 8 illustrates an anomaly localization system according to embodiments of the present disclosure; and

FIG. 9 is a flowchart of operations according to one embodiment of the present disclosure

Although the following Detailed Description will proceed with reference being made to illustrative embodiments, many alternatives, modifications and variations thereof will be apparent to those skilled in the art.

### DETAILED DESCRIPTION

The systems and methods provided herein take advantage of the fact that the incident guided wave pulse is distorted in phase and amplitude when passing any mechanical attachments that are acoustically coupled to the section of the waveguide being inspected.

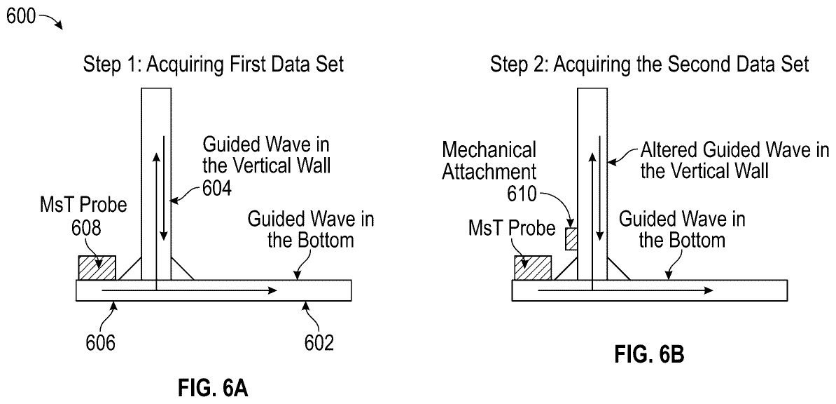

FIG. 6a illustrates a branched structure 600 that includes a tank bottom 602 and a sidewall structure 604 according to one embodiment of the present disclosure. A flange or “skirt” portion 606 of the tank bottom is illustrated where the skirt portion 606 extends beyond the sidewall 604. A probe 608 is disposed on the bottom 602, on or near the flange 606. FIG. 6b illustrates the branched structure 600 of FIG. 6a and also includes a signal modifying device 610 coupled to the vertical wall 604, near the junction of the vertical wall 604 and bottom 602. As described below, a multi-phase procedure to determine anomalies associated with a branch of a branched structure 600 is provided as follows:

Phase 1: Acquire a first data set using the probe 608 attached to the structure 600. As preferred examples, a magnetostrictive (MsT) probe or piezoelectric probe coupled to the tank bottom skirt portion 606 is shown in FIG. 6a. The probe 608 may include a single-element, multi-segmented linear or collar probe, as is well known. The first data set includes reflected signals from both branches 602 and 604.

Phase 2: Acquire a second data set after attaching the signal modifying device 610. The signal modifying device 610 is preferably an acoustically-coupled strip, bar or strap, etc. using magnets or other mechanical attachment methods to the branched structure of interest (e.g., the vertical wall 604). As an example, FIG. 6b shows a preferred MsT probe 608 coupled to the tank bottom skirt 606 with a magnetic strap 610 mechanically attached and acoustically coupled to the vertical wall 604.

Phase 3: Data acquired at step 1 is subtracted from the data acquired at step 2. The subtraction process will remove any non-altered signals in the original waveform. This alteration may be in the form of an amplitude shift, phase shift, or a combination thereof. For example, if the signal modifying device is placed on the vertical wall, all reflections from the tank bottom will be unchanged and removed using, for example, a known synthetic focusing algorithm. As is known, synthetic focusing of guided wave ultrasound is a method for indication localization in materials by computationally reconstructing a focused acoustic field at specific locations from multiple transducer positions. This creates a mapping effect by changing delays of signals to focus in on an anomaly to provide location information (in the x-y directions). Thus, only the modified signals from the vertical wall will remain. The resulting waveform should preferably have zero (or near zero) indications from the tank bottom plate because the two data acquisition sessions are performed within a relatively short interval.

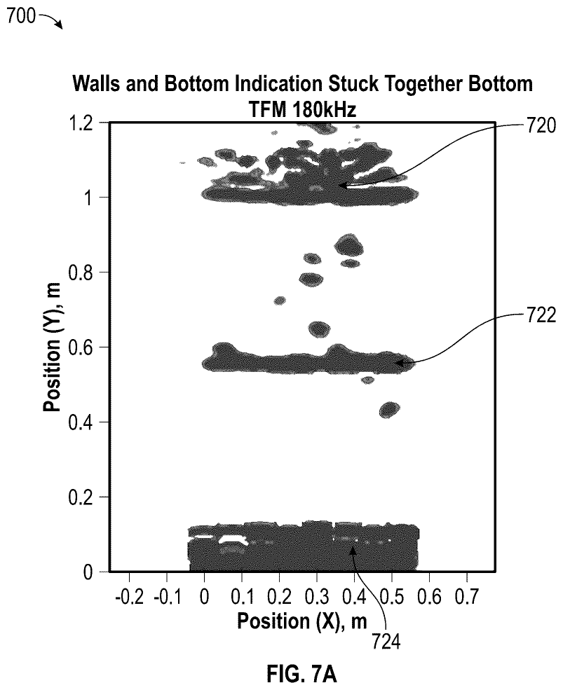

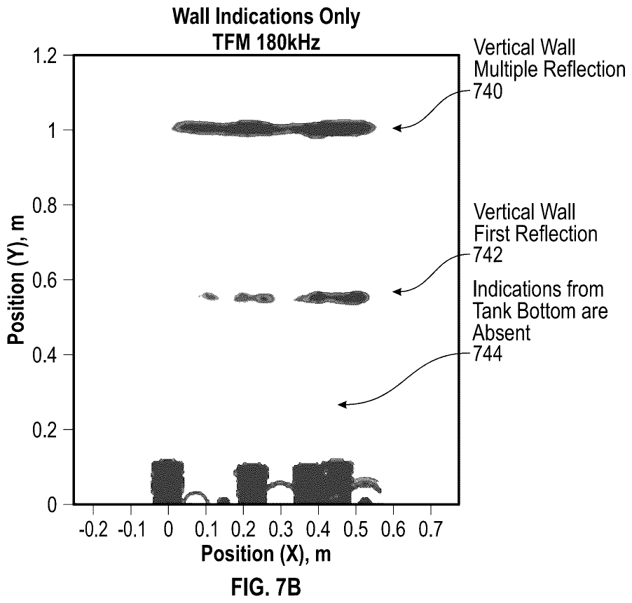

FIG. 7b illustrates a plot, e.g., a color map plot (synthetic view of the data that reveals anomalies) of the results of applying the three-step procedure to the storage tank in comparison with the plot of the results using conventional guided wave inspection data (FIG. 7a). FIGS. 7a and 7b are with reference to x-y position relative to the probe, and may be derived using synthetic focusing, where a position of the anomalies correspond to noted x-y locations on the plots. Recall that using conventional guided wave inspection techniques will result in overlap of indications from the bottom and wall, as indicated at 720, 722 and 724 of FIG. 7a. The technique herein suppresses the indications from the tank bottom, leaving only indications from the tank wall 604 in the final image, as shown at 740, 742 and 744 of FIG. 7b.

The choice of where to place the mechanical and/or magnetic attachment depends on where anomalies are trying to be detected. For instance, if this method is applied for screening of a branch pipe, the mechanical attachment is preferably placed at location near the branch (FIG. 6b). If this method is applied for screening of the bottom of a pipe on a pipe support, the mechanical attachment is preferably placed at the location shown in FIG. 4. If this method is applied for screening of a main suspension cable, the mechanical attachment is preferably sequentially placed on each of the branching strands (FIG. 5).

The methodology described herein provides isolation of indications originating from one or another part of structure that has a branching waveguide. Advantageously, the methodology described herein may be applied to industrial components to separate indications in cases where guided waves propagate in multiple branching attachments, such as wire strands in bridge cables, branch pipes in pipelines, storage tank wall-bottom structures, ship hulls with multiple welded frame components, etc.

One other additional valuable application of this methodology is to index indications located at different segments of a pipe. For example, indications originating from the pipe bottom could be isolated from all other indications. The effect could be accomplished using non segmented (full ring) guided wave collars. Indexing is an equivalent to proper marking of indications. When a final plot has two or more indications with a different origin (some from the main waveguide and some from the branching waveguide) they need to be marked accordingly.

The mechanical attachment could be preferably made from a chain of magnets, belt of magnets, metal or composite strap, elastic tape acoustically coupled to the structure.

The method herein can be equally applicable to any type of guided wave collars and transduction method, including e.g., magnetostrictive, piezoelectric, laser, and air-coupled ultrasonic generators. The method is also applicable for sensors arrays utilizing phased array test methods.

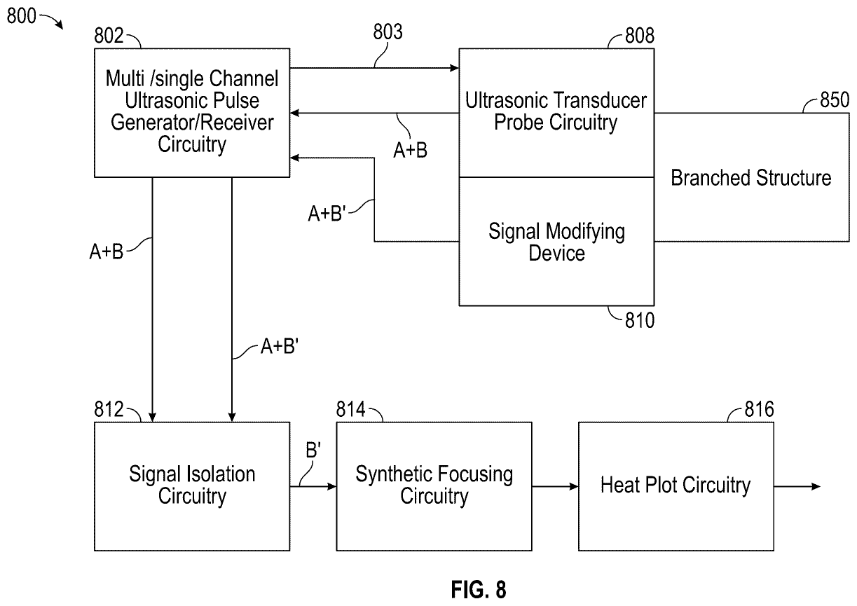

FIG. 8 illustrates an anomaly localization system 800 according to embodiments of the present disclosure. With continued reference to FIGS. 6a, 6b, 7a and 7b, the system 800 includes ultrasonic pulse generator/receiver circuitry 802 generally configured to generate an ultrasonic pulse signal 803 having known frequencies, e.g., on the order of 60 kHz, 120 kHz, 180 kHz, etc. The ultrasonic pulse generator/receiver circuitry 802 may be embodied as known ultrasonic pulse systems, for example, a guided wave probe. In one example embodiment, the ultrasonic pulse generator/receiver circuitry 802 is a MSSRV5M pulse generator/receiver produced by Southwest Research Corporation, and coupled to a multi-segment sensor. In another example embodiment, single channel probes may be driven by the aforementioned MSSRV5M pulse generator/receiver.

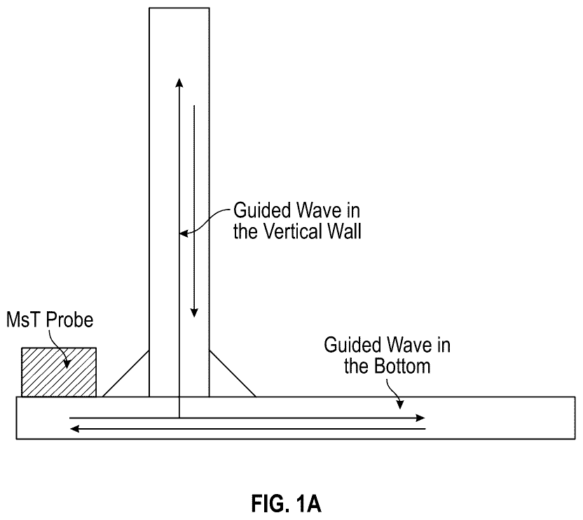

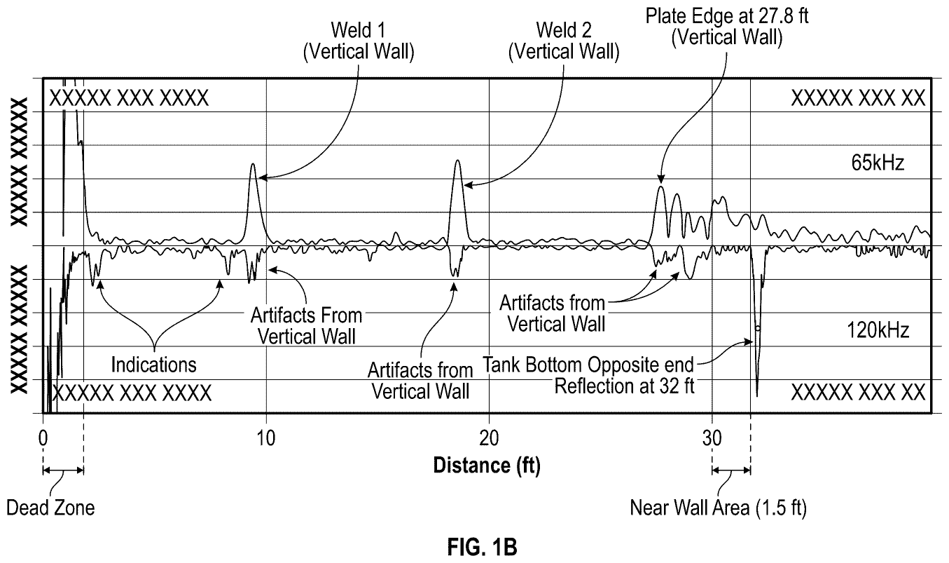

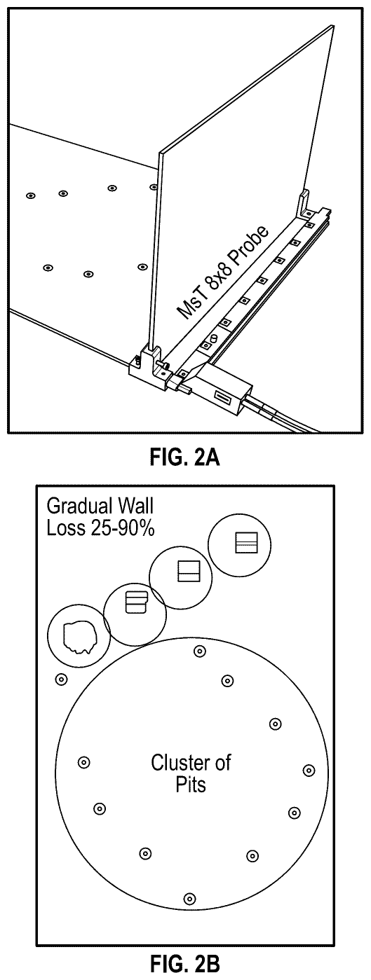

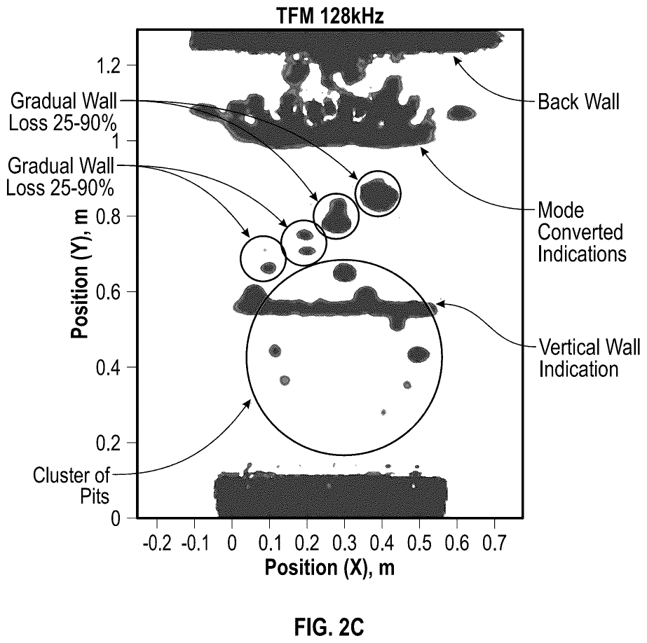

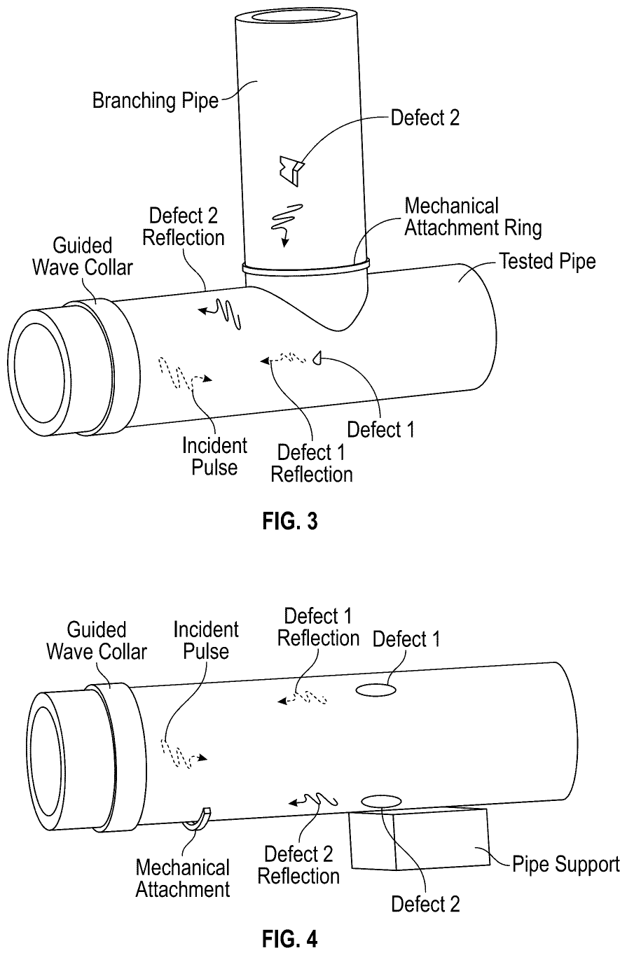

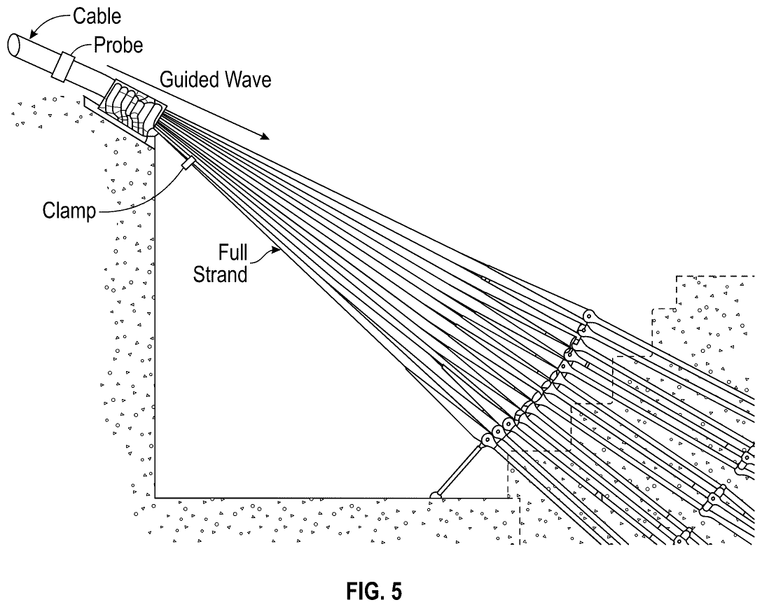

As described below, the ultrasonic pulse generator/receiver circuitry 802 is also configured to receive ultrasonic reflected signals through a bifurcated apparatus, such as illustrated in FIGS. 1-6.

The system 800 also includes ultrasonic transducer probe circuitry 808 generally configured to be coupled to the ultrasonic pulse generator/receiver circuitry 802 and to a branched structure 850 (as generally described above with reference to FIGS. 1-7 and may include pipes, tank walls, tank bottoms, steel ropes, buried anchor rods, heat exchanger tubing, and other industrial structures, etc.). The probe circuitry 808 may include a magnetostrictive (MsT) probe or piezoelectric probe coupled to a selected location of the branched structure, for example, coupled to the tank bottom skirt is shown in FIG. 6a. The probe 808 may include a multi-segmented linear or collar probe, as is well known, and is generally configured to transmit ultrasonic signals (803) from the ultrasonic pulse generator/receiver circuitry 802 to the branched structure and to receive ultrasonic signals reflected through the various branches of the branch structure 850.

During Phase 1 of data acquisition (described above), the ultrasonic probe 808 is coupled to the branched structure 850 during which the ultrasonic signal 803 is applied to the branched structure 850 and reflected ultrasonic signals (designated A+B FIG. 8) are sent to the pulse generator 802. In one example and assuming the branched structure shown in FIG. 6a, the signal A+B represents the combined signal components from the bottom member 602 (represented by signal component A) and the vertical wall member 604 (represented by the signal component B). The heat plot of FIG. 7a illustrates a visual representation of signal A+B in which anomalies for both the bottom portion (602) and sidewall portion 604 are combined.

The system 800 further includes a signal modifying device 810 that is coupled to the branched structure 850 during Phase 2 of the operations described herein. More specifically, the signal modifying device 810 is coupled to a branch of interest of the branched structure, such as the vertical wall member 604 as illustrated in FIG. 6b. As a general matter, and as described above, the signal modifying device 810 is generally configured to alter (or, modify) the signal component B of the reflected signal to produce a modified signal B′. Also, as a general matter, the signal modifying device 810 is generally configured to attenuate and/or change the phase of signal B to produce B′. Thus, during Phase 2 when the signal modifying device 810 is coupled to the branch structure 850, the ultrasonic signal 803 produces a reflected signal A+B' as a result of the signal modifying device 810. It is preferred that operations of Phase 2 follow after the operations of

Phase 1 before any alterations or modifications of the branched structure 850 can occur (for example, Phase 2 occurs within 1 hour of Phase 1, before any temperature changes occur in the branched structure, etc.).

The signal modifying device 810 may be a metal bar, strap, metal collar, set of linear magnets, etc. The size of the signal modifying device 810 is selected so that signal B′is sufficiently disrupted in amplitude and/or phase compared to signal B. In some embodiments, the signal modifying device 810 is selected to have a size of at least ¼ wavelength of the signal 803 in at least one dimension to ensure sufficient phase shift and/or attenuation of the original signal appears in the reflected signal.

The system 800 also includes signal isolation circuitry 812 generally configured to isolate the modified signal B′ from the reflected signal (A+B) determined during Phase 1 and the reflected signal (A+B') determined during Phase 2. In some embodiments, the isolated modified signal may be determine as:

(A+B)−(A+B′)=B−B′, where B′=B+AB. Since signal component A is “subtracted out” it is therefore a known, and thus, signal component B is likewise known. Therefore, B−B′ may be further refined to AB, where AB represents the disturbance added to the reflected signal components in the portion of the branched structure 850 where the signal modifying device 810 is attached.

The system 800 may also include image reconstruction circuitry 814 generally configured to Image construction circuitry 814 may include, for example, known TFM (Total Focusing Methods), SAFT (Synthetic Aperture Focusing Technique), CFM (Common Source Focusing Method or Plain Wave Imaging Method), other synthetic or conventional ultrasound image formation techniques. The output of which may be used to generate one or more plots, such as the A-scan plots shown in FIGS. 7a and 7b.

The system 814 also include heat plot circuitry 816 generally configured to generate a heat plot of anomalies associated with the target branch of the branched structure 850, such as shown in FIGS. 7a and 7b. Thus, anomalies associated with a target branch of the branched structure 850 may be isolated and visualized.

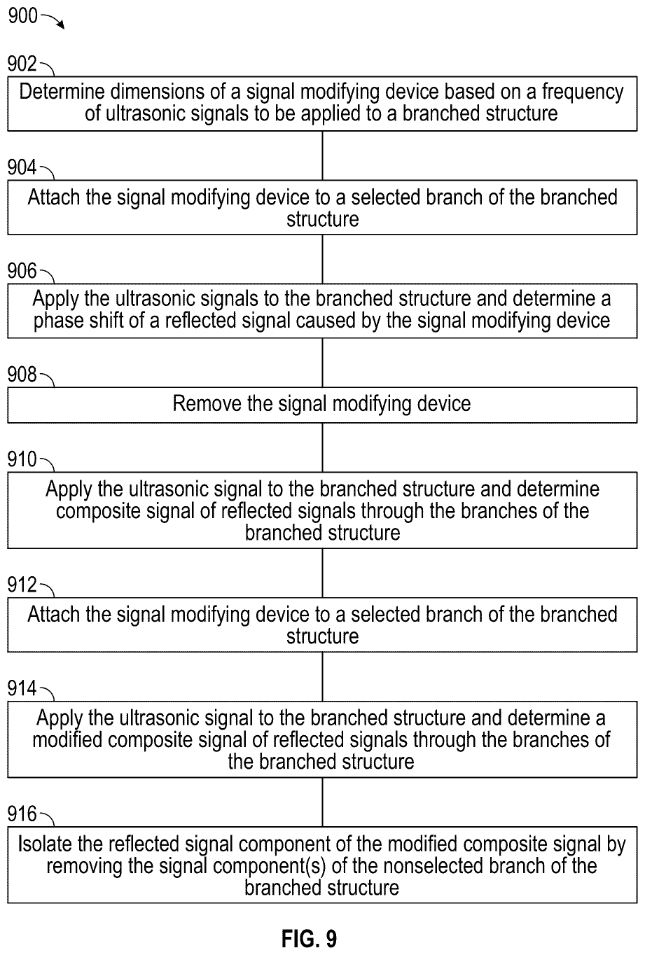

FIG. 9 is a flowchart 900 of operations according to one embodiment of the present disclosure. The flowchart 900 of FIG. 9 illustrates operations that may be performed by the various components of the system 800 described above with reference to FIG. 8. Operations of this embodiment include determining the dimensions of a signal modifying device, to be coupled to a selected branch of a branched structure, where at least one dimension is based on a frequency of ultrasonic signals to be applied to a branched structure 902. As described above, the signal modifying device should have sufficient thickness, length and/or width to cause discernable attenuation and/or phase shift to an ultrasonic signal (for example, the signal modifying device is selected to be at least ¼ of a wavelength of the ultrasonic signal in at least one dimension).

Operations of this embodiment also include applying the ultrasonic signals to the branched structure and determining a composite signal of reflected signals through the branches of the branched structure 904. Operations of this embodiment further include attaching the signal modifying device to a selected branch of the branched structure 906. Operations further include applying the ultrasonic signals to the branched structure and determining a modified composite signal of reflected signals through the branches of the branched structure 908. Operations further include isolating the reflected signal component, of the modified composite signal, of the reflected signal in the selected branch by removing the signal components of the non-selected branch of the branched structure 910.

The embodiments and examples described herein may be implemented using, for example, software (e.g., instruction sets) and various hardware components (e.g., circuitry, sensors, processors, etc.) to achieve the advantages and features described herein.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Software may be embodied as a software package, code, instructions, instruction sets and/or data recorded on non-transitory, computer-readable storage devices. Firmware may be embodied as code, instructions or instruction sets and/or data that are hard-coded (e.g., nonvolatile) in memory devices. “Circuitry”, as used in any embodiment herein, may comprise, for example, dedicated ultrasonic generator systems (as are known in the art) and ultrasonic probe systems as are known. “Circuitry” may also include, singly or in any combination, hardwired circuitry, programmable circuitry such as processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

As used in any embodiment herein, the terms “system” and/or “circuit” may refer to, for example, software, firmware and/or circuitry configured to perform any of the aforementioned operations. Any of the operations described herein may be implemented in a system that includes one or more non-transitory storage devices having stored therein, individually or in combination, instructions that when executed by circuitry perform the operations. Here, the circuitry may include any of the aforementioned circuitry including, for example, one or more processors, ASICS, ICs, etc., and/or other programmable circuitry. Also, it is intended that operations described herein may be distributed across a plurality of physical devices, such as processing structures at more than one different physical location. The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed is:

1. An anomaly localization system for use with a branched structure, the system comprising:
ultrasonic pulse generator/receiver circuitry configured to generate ultrasonic pulse signals and to receive composite ultrasonic pulse reflection signals;
probe circuitry removeably coupleable to the branched structure, the probe circuitry configured to apply the ultrasonic pulse signals to the branched structure, receive composite ultrasonic pulse signals from the branched structure in response to the ultrasonic pulse signals, and transmit the composite ultrasonic pulse signals; wherein the composite ultrasonic pulse signals represent signal components from branches of the branch structure;
a signal modifying device removably coupleable to a selected branch of the branch structure; the signal modifying device to modify the ultrasonic pulse signals to generate modified composite ultrasonic pulse reflection signals; and
signal isolation circuitry configured to isolate the modified ultrasonic pulse reflection signal from the modified composite ultrasonic pulse reflection signals to isolate anomalies present in the selected branch of the branch structure.

2. The system of claim 1, wherein the ultrasonic pulse generator/receiver circuitry is selected from a multi-channel ultrasonic pulse generator/receiver or a single channel ultrasonic pulse generator/receiver.

3. The system of claim 1, wherein the probe circuitry is selected from a magnetostrictive (MsT) probe or piezoelectric probe.

4. The system of claim 1, wherein the signal modifying device is selected from an an acoustically-coupled strip, bar or strap removably coupleable to a selected branch of the branch structure; and wherein at least one dimension of the signal modifying device is selected to be at least ¼ wavelength of the ultrasonic pulse signals.

5. A system of claim 1, wherein the signal modifying device is configured to cause an attenuation and/or phase shift of the composite ultrasonic pulse reflection signals compared to the ultrasonic pulse signals.

6. The system of claim 1, wherein the branched structure is a tank and wherein a first branch is a bottom of the tank and second branch is a sidewall of the tank; and wherein the signal modifying device is removably coupled to the sidewall of the tank to determine one or more anomalies associated with the sidewall based on the isolated modified ultrasonic pulse reflection signal.

7. A method for anomaly localization in a branched structure, the method comprising:
coupling an ultrasonic pulse generator/receiver circuitry and probe circuitry to the branched structure and generating ultrasonic pulse signals through the branched structure and receiving composite ultrasonic pulse reflection signals; wherein the composite ultrasonic pulse signals represent signal components from branches of the branch structure;
coupling a signal modifying device to a selected branch of the branch structure; the signal modifying device to modify the ultrasonic pulse signals to generate modified composite ultrasonic pulse reflection signals; and
isolating the modified ultrasonic pulse reflection signal from the modified composite ultrasonic pulse reflection signals to isolate anomalies present in the selected branch of the branch structure.

8. The method of claim 7, wherein the ultrasonic pulse generator/receiver circuitry is selected from a multi-channel ultrasonic pulse generator/receiver or a single channel ultrasonic pulse generator/receiver.

9. The method of claim 7, wherein the probe circuitry is selected from a magnetostrictive (MsT) probe or piezoelectric probe.

10. The method of claim 7, wherein the signal modifying device is selected from an an acoustically-coupled strip, bar or strap removably coupleable to a selected branch of the branch structure; and wherein at least one dimension of the signal modifying device is selected to be at least ¼ wavelength of the ultrasonic pulse signals.

11. A method of claim 7, wherein the signal modifying device is configured to cause an attenuation and/or phase shift of the composite ultrasonic pulse reflection signals compared to the ultrasonic pulse signals.

12. The method of claim 7, wherein the branched structure is a tank and wherein a first branch is a bottom of the tank and second branch is a sidewall of the tank; and wherein the signal modifying device is removeably coupled to the sidewall of the tank to determine one or more anomalies associated with the sidewall based on the isolated modified ultrasonic pulse reflection signal.

13. A non-transitory storage device that includes machine-readable instructions that, when executed by one or more processors, cause the one or more processors to perform operations to determine anomaly localization in a branched structure, the operations comprising:
generate ultrasonic pulse signals through the branched structure and receiving composite ultrasonic pulse reflection signals; wherein the composite ultrasonic pulse signals represent signal components from branches of the branch structure;
modify, using a coupling a signal modifying device removeably coupled to a selected branch of the branch structure, the ultrasonic pulse signals to generate modified composite ultrasonic pulse reflection signals; and
isolate the modified ultrasonic pulse reflection signal from the modified composite ultrasonic pulse reflection signals to isolate anomalies present in the selected branch of the branch structure.

14. The non-transitory storage device of claim 13, wherein the signal modifying device is selected from an acoustically-coupled strip, bar or strap removably coupleable to a selected branch of the branch structure; and wherein at least one dimension of the signal modifying device is selected to be at least ¼ wavelength of the ultrasonic pulse signals.

15. The non-transitory storage device of claim 13, wherein the signal modifying device is configured to cause an attenuation and/or phase shift of the composite ultrasonic pulse reflection signals compared to the ultrasonic pulse signals.

16. The non-transitory storage device of claim 13, wherein the branched structure is a tank and wherein a first branch is a bottom of the tank and second branch is a sidewall of the tank; and wherein the signal modifying device is removeably coupled to the sidewall of the tank to determine one or more anomalies associated with the sidewall based on the isolated modified ultrasonic pulse reflection signal.
